(19) United States
(12) Patent Application Publication
(10) Pub. No.: US 2012/0275556 A1
(43) Pub. Date: Nov. 1, 2012

(54) METHOD AND APPARATUS FOR NOVEL NEUTRON ACTIVATION GEOMETRIES IN A FLOWING CARRIER STREAM

(76) Inventors: Andrew Gerard William Murray, East Reservoir (AU); Anthony Gordon Bartel, East Hawthorn (AU)

(21) Appl. No.: 13/498,079

(22) PCT Filed: Sep. 24, 2010
(86) PCT No.: PCT/AU2010/001248

§ 371 Date: Jul. 17, 2012

(30) Foreign Application Priority Data
Sep. 25, 2009 (AU) 2009904654

(51) Int. Cl. G21G 1/06; G21C 17/00

(52) U.S. Cl. 376/159; 376/158; 376/246

(57) ABSTRACT

The present invention provides a nuclear activation apparatus for one or more fluid samples comprising the following modules;
a means for introducing one or more fluid samples to a sample conduit,
an activation thimble, comprising a section of sample conduit configured for multiple passes adjacent a radiation source,
an absorber located adjacent to the activation thimble, and
a detector located adjacent the sample conduit,
   wherein the relative arrangement of the modules can be altered specific to an application and the rate of flow of the fluid sample adjacent the radiation source can be controlled.

### FIELD OF INVENTION

The present invention relates to the field of neutron activation of flowing streams, particularly neutron activation for detection of radio chemical decay.

More particularly the method system and apparatus can be applied to conventional analytical determinations, basic chemical synthesis with activated reagents and chemical synthesis in vivo. In particular the latter may include chemical synthesis in isolated tissues where complex biological structures such as cells or cell organelles provide and participate in chemical interactions.

In one particular aspect the present invention is suitable for use in chemical analysis and synthesis, including in vivo, in vitro and in vivo-in vitro.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Neutron activation is the process in which neutron radiation induces radioactivity in materials, and occurs when atomic nuclei capture free neutrons and enter excited states. The excited nucleus often decays immediately by emitting alpha, beta or gamma particles. The neutron capture even after any immediate decay, often results in the formation of an unstable activation product. Such radioactive nuclei can exhibit half-lives ranging from fractions of a second to many years.

In chemistry, neutron activation analysis is a technique used to very accurately determine the concentrations of elements in a sample. The particular advantage of this technique is that it does not destroy the sample, and thus has been used for analysis of works of art and historical artifacts.

The sample is introduced into the intense radiation field of a nuclear reactor. The sample is thus bombarded with neutrons, causing the elements to form radioactive isotopes. The radioactive emissions and radioactive decay paths for each element are well known. Using this information it is possible to study spectra of the emissions of the radioactive sample, and determine the concentrations of the elements within it.

The activation of atomic species in solid phase materials is commonplace. However, neutron activation is more difficult to apply to atomic species in a flowing stream. Neutron activation in flowing streams is often used as a direct analytical probe, particularly for metal species. Neutron activation is also suited to preparative processes in flowing streams when they generate other activation and subsequent decay events that can elucidate atomic or molecular interactions in very complex systems.

There are several factors to be considered with regard to the irradiation of a flowing stream with a neutron source. First, it is desirable that the neutron source be in close proximity to the flowing stream so as to obtain optimum utilisation of the source. Also, it is desirable that the neutron source be positioned adjacent a sample conduit carrying the process stream, in a configuration amenable to the generation of thermalised neutrons. Preferably the neutron source uniformly irradiates all parts of the process stream and makes the most efficient use of the source, which emits neutrons in all directions uniformly. It is also desirable that the system be configured to allow removal of the neutron source and its housing from the vicinity of the process stream, for example to service or replace the source.

Prior art attempts at neutron activation in a flowing stream focused around wide bore pipes, such as conduits associated with fissile reactor technology (where the neutron source was in close proximity) carrying wastewater or water conduits from bores. The use of a continuously flowing stream having a comparatively large cross section according to these prior art methods provided only limited control of the incident radiation.

U.S. Pat. No. 4,464,330 describes a complex apparatus for irradiating a continuously flowing stream of fluid, consisting of a housing having a spherical cavity and a spherical moderator containing a radiation source positioned within the spherical cavity. The housing includes fluid intake and output conduits which open on the spherical cavity and conducts fluid around the spherical moderator to provide uniform irradiation due to the 47 steradian geometry.

U.S. Pat. No. 3,479,508 describes a process and apparatus for neutron activation in liquid samples which includes a complex conformation of components. Other systems and apparatus are described for metal analysis (U.S. Pat. No. 3,898,042; U.S. Pat. No. 4,293,379) quantitative water flow measurement (U.S. Pat. No. 5,461,909) and biological applications such as analysis of body composition (Palmer et al, Phys. Med. Biol. 1968, Vol. 13, No. 2, 269-279). Prior art systems and apparatus of this type are typically application specific, constructed for one purpose only, and cannot be adapted to other purposes.

U.S. Pat. No. 4,568,511 and UK 1409480 describe industrial scale neutron activation systems for the analysis of metal ions distributed through non-homogeneous slurry. Both systems employ conduits that permit free mixing as the slurry advances through the conduits. However the conformations of each of these systems cannot be reconfigured for different targets and sources. Furthermore, the configurations taught and disclosed in these patents impose significant limitations in regard to activation. For example the device of UK 1409480 requires two separate activation sources—one that generates flux incorporating thermal neutrons and the other flux being devoid of thermal neutrons. This limits the system to having a conduit that is sequentially looped around each of the source cores. The device of U.S. Pat. No. 4,568,511 has a single activation source (typically Californium-252 or Americium-Beryllium) but it is surrounded by a cell having two separate systems—a holding tank and an inner cell—wherein the slurry moves sequentially from one system to the other.

These systems, and other systems of the prior art such as the one described in US 2003/0007588 typically use narrow bore conduits and conduit loops, however these types of systems typically do not permit control of the rate or direction in which fluid sample can be passed through the conduits. Furthermore they typically do not permit mixing between a carrier stream and the sample.

### SUMMARY OF INVENTION

An object of the present invention is to provide an apparatus for irradiating a fluid flowing in a process stream.

It is also an object of the invention to provide an apparatus for irradiation of flowing fluid wherein the radiation source is positioned so as to obtain an optimal geometry for irradiation.

It is also an object of the present invention to provide an apparatus that permits control of the rate and direction of flowing fluid in the vicinity of a radiation source to optimise radiation of the fluid.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a nuclear activation apparatus and system for one or more fluid samples comprising the following modules;
a means for introducing one or more fluid samples to a sample conduit,
an activation thimble, comprising a section of conduit configured for multiple passes adjacent a radiation source,
an absorber located adjacent to the activation thimble, and
a detector located adjacent the sample conduit,
   wherein the arrangement of the modules can be altered specific to an application and the rate of flow of the fluid sample adjacent the radiation source can be controlled.

Preferably the nuclear activation is neutron activation.

The system may optimally comprise other modules, such as a flow cell to improve sensitivity at the detector.

In a second aspect of embodiments described herein there is a system for assembly of a nuclear activation apparatus, the system comprising;
a first module including means for introducing one or more fluid samples to a sample conduit,
a second module including an activation thimble, comprising a section of sample conduit configured for multiple passes adjacent a radiation source,
a third module including an absorber located adjacent to the activation thimble, and
a fourth module comprising a detector located adjacent the sample conduit,
   wherein the relative arrangement of the modules can be altered specific to an application and the rate of flow of the fluid sample adjacent the radiation source can be controlled.

Typically the rate of flow of the fluid sample adjacent the radiation source is controlled by a pump or similar means. Peristaltic pumps are particularly preferred and allow for both low and moderate volume throughputs in conduits, particularly narrow bore conduits. A range of flow rates can be calibrated and implemented and flow can be in the forward direction (towards the detector) or reverse direction of halted. It may be desirable to reverse the flow direction in the activation thimble to increase exposure of fluid to the radiation source, or halt the flow to increase exposure time.

Narrow bore conduits are preferred because they can provide an isolated sample zone in a flowing fluid carrier stream. Preferably there is no mixing between the carrier stream and the sample zone. Narrow bore conduits can also be used to provide a definite and preferred cross sectional profile.

Thus the interaction of the source and the fluid sample, allowing for the contribution of any absorber and/or support can be significantly improved.

### Sample Introduction Means

The means for introducing the samples typically comprises a rotary valve for sample introduction in flow injection or sequential injection mode. In flow injection mode, the valve typically has six ports and a sample loop of known volume. In sequential injection mode, the number of ports is more numerous. In preparatory mode, the samples do not need to be introduced using an injection valve.

The apparatus can also be used in an automated mode to facilitate high sample throughput, for example, by introducing samples using an auto-injection robot before an injection valve. The actual rate of sample throughput will depend upon the residence time of the sample zone in both the activation thimble (time for efficient activation) and the flow cell over the detector (time to collect reliable counting statistics).

### Radiation Source

The radiation source may be of any convenient type and is preferably a neutron source or beta source. Neutrons are often referred to as ‘hot’, ‘thermal’ or ‘cold’, which indicates the free neutron's kinetic energy. For example Californium-252, preferably from a medical source, is used for many applications requiring compact, portable and reliable source of neutrons. In the past cold neutrons from a fissile reactor have been employed. However the system of the present invention makes it possible to use the more attractive medical grade thermal neutron source.

Radiation sources of the type used in the present invention are typically suspended in a matrix such as water, silicone based elastomer, polyethylene or paraffin, often including a metal such as boron, cadmium or hafnium. For example ²⁵²Cf is commonly supplied in a block of paraffin, particularly borated paraffin, in a steel walled container. The borated paraffin ‘thermalises’ the neutrons from the ²⁵²Cf.

### Neutron Activation Thimble

In a second aspect of embodiments described herein there is provided an activation thimble typically comprising a section of the sample conduit configured to include multiple loops or coils that can be located adjacent a radiation source. This type of configuration creates an extended residence time for the sample in close proximity to the radiation emitted by the source and addresses the loss of energetic yield of the radiation flux when the activation source is medical grade.

The thimble may further comprise a support that does not contribute significantly to the decay spectrum of the sample. Typically the support is wrapped in loops or coils of the sample conduit. By stacking thimble supports of decreasing radius or by offsetting thimble supports (either of the same or differing dimensions) eccentricities in the conduits can be introduced that do not hinder flow through the conduit yet promote helical flow. This provides the advantage of providing a changing profile of the fluid sample as it flows through the conduit in the vicinity of the radiations source.

### Absorber

An absorber is any material that ‘stops’ or modifies ionizing radiation. The apparatus of the present invention may comprise an absorber conduit or an absorber in another form such as a solid block When an absorber conduit is used, preferably the portion of the absorber conduit in the vicinity of the source is perpendicular to, and adjacent the loops or coils of the sample conduit in the activation thimble. The absorber conduit may have any convenient conformation and also typically comprises loops or coils.

Alternatively the absorber block supplied with the radiation source may be utilised as part of the apparatus of the present invention. For example, neutron activation sources are typically supplied with a block of borated paraffin absorber material situated adjacent to the source. But the absorber material may be modified by removing a cylinder of the borated paraffin and inserting a guide tube of arbitrarily sufficient diameter to accommodate a large activation thimble. The large activation thimble can then be fitted by inserting and sliding it along the guide tube. The guide tube may be omitted altogether. In this instance, the cylinder of borated paraffin can then be machined to a shape of suitable diameter and inserted into the internal volume of the activation thimble. This assembly is inserted into the empty volume in the absorber block, effectively sandwiching it between the cylinder of borated paraffin and the main bulk of the borated paraffin block.

Preferably the absorber is homogeneous in composition and structure. With particular reference to paraffin, this material typically includes both amorphous and crystalline or semi-crystalline regions. This heterogeneity may result in a loss of efficiency in generating thermal neutrons and alternative materials or composites may be preferable. For example, paraffin borosilicate glass sandwiches or conduits coated in borosilicate glass may introduce the unit cell regularity of the glass and reduce the structural irregularities as compared to using paraffin alone.

### Flow Cell

The term ‘flow cell’ is well known in applications such as flow injection analysis and liquid chromatography. The flow cell typically contains a volume of solution in close proximity to a radio chemical detector. However ‘flow cell’ may also be used for the detector sensor volume used in other techniques, such as neutron activation.

The apparatus and system of the present invention may further comprise a flow cell in close proximity to the detector to provide a reaction regimen to enhance both selectivity and sensitivity.

The sample conduit conformation allows for optimisation of the residence time of the sample in the sample zone over the detector. The appropriate conformation will vary with the application. Although this arrangement may be based on conformations typically found in flow injection analysis or gas diffusion cells, fundamental modifications will be required for application to the present apparatus and system.

For example, a pegboard flow cell may be used to control profile and residence time over the detector. This type of detector comprises a regular array of pegs around which the sample conduit can be wrapped, creating a flow path that passes back and forth across the detector.

### Detector

It will be readily apparent to the person skilled in the art that the detector can be chosen from any of the detectors well known in the art and appropriate for a given application.

Even with a single sample conduit, detector array combinations may be used that include separate detectors in series, dedicated to monitoring different radio chemical decay modes in a sample. With multiple sample conduits detector arrays can be situated to monitor different conduits for the same decay events or the same conduit for different decay events.

### Applications

In yet a further aspect of embodiments described herein there is provided a method of analysis using the apparatus of the present invention. When used for analysis of metals in solution the analysis is based on the permitted energy transitions specific to given metal nuclei and sensitivity will be based on the probability of incident thermalised neutrons interacting with metal nuclei distributed throughout the solution bulk, within the sample conduit.

In yet further aspects of embodiments described herein the apparatus, system and method of the present invention can be used for applications including, but not limited to the following:
radio labelling reactants for chemical synthesis;
synthesis of radio labelled chemicals;
activation of medical therapeutics (such as Pt in platinum based cancer drugs);
investigation of reaction kinetics;
diagnostics;
investigation reaction steps; and
process monitoring.

In particular, there is provided an apparatus for neutron activation of one or more fluid samples of a chemical reaction, the apparatus comprising the following modules:
a means for introducing one or more reactants to a reaction zone to form a fluid sample,
a sample conduit,
an absorber,
an activation source in close proximity to an activation thimble, where the sample conduit is wrapped around a thimble support and the absorber is located adjacent to the sample conduit; and
a detector
   wherein the relative arrangement of the modules can be altered to suit specific reactions.

The present invention further provides unique methods for use with the apparatus of the present invention. In a further aspect of embodiments described herein there is provided a method of calibrating a pump when used in the apparatus of the present invention the method comprising the steps of:
(i) marking a length of the sample conduit with uniform graduations,
(ii) starting the pump to expel any dissolved gas in the sample conduit,
(iii) filling a sample loop within the sample introduction means with a solution containing a chromophore active in the visible region of the electromagnetic spectrum to form a sample zone,
(iv) activating the sample introduction means to introduce the sample zone to a carrier stream in the sample conduit,
(v) record the time taken for the sample zone front and tail to reach each of the graduations marked on sample conduit, and
(vi) calculating pumping rate based on the times recorded.

The calculation may, for example include the step of calculating a coefficient of variance for the sample zone front and tail to provide a point of correlation against a conventional pump calibration method.

A further novel method provided by the present invention relates to spectral decomposition of a sample prior to injection into the apparatus of the present invention. In particular the present invention provides a method of calculating the background contribution of the carrier and air in the apparatus of the present invention including a sample pump and sample cell, the method comprising the steps of:
(i) pumping a first component of the carrier through the sample conduit at a required flow rate until it reaches a point just prior to the activation thimble;
(ii) suspending pumping while a volume of the first component (first blank) is irradiated;
(iii) recommencing pumping until the first blank enters of the flow cell;
(iv) suspending pumping to count radiochemical decay events in the first blank for an arbitrary time;
(v) pumping to expel the first blank from the sample conduit;
(vi) pumping a second and any subsequent components of the carrier into the sample conduit and repeating steps 1 to 6; and
(vii) using the counts from the first and any subsequent blanks to calculate background radiochemical decay.

In particular the present invention provides a method of calculating the contribution of the aqueous stream of carrier and any dissolved air conveying the sample in the sample conduit. In a further aspect of embodiments described herein there is provided a method of spectral decomposition using the apparatus of the present invention including a sample pump and sample cell, the method comprising the steps of:
(i) pumping water through the sample conduit at a required flow rate until the meniscus of the air/water interface reaches a point just prior to the activation thimble;
(ii) suspending pumping while a volume of air (first blank) in front of the meniscus and a volume of water (second blank) are irradiated;
(iii) recommencing pumping until the meniscus reaches the entrance of the flow cell;
(iv) suspending pumping to count radiochemical decay events in the first blank for a time t;
(v) recommencing pump flow until the second blank enters the flow cell;
(vi) suspending pumping to count radiochemical decay events in the second blank for time t;
(vii) pumping to expel the first and second blanks from the sample conduit;
(viii) pumping carrier into the sample conduit and repeating steps 3 to 7; and
(ix) using the counts from the first blank and the second blank to calculate background radiochemical decay.
   The above steps may be repeated until the desired level of reliability and reproducibility is achieved.

Other aspects and preferred forms are disclosed in the specification and/or defined in the appended claims, forming a part of the description of the invention.

Advantages provided by the present invention comprise the following:
improved interaction between the source and the sample;
improved interaction between the source and any absorber, (for example in the case of a neutron source, potentially leading to improved yield of thermal neutrons);
all conduits in the system delivers materials from a sealed reservoir to a sealed waste container, thus keeping all radiochemical and toxic chemical hazards from the laboratory environment;
the thimble of the present system enables the use of a medical grade source thus avoiding the use of fissile technology;
selectivity and sensitivity of analysis for very small sample volumes;
very little wastage of consumables because of the low volumes of reagent required;
the system can be scaled up or miniaturised according to need;
all components may be fabricated from medical grade plastics or glass thus permitting modifications to the system to be made relatively easily and at low cost;
the modularity of the system lends itself well to modification and adaptation to new applications;
users with a basic understanding of analytical chemical techniques such as liquid chromatography will have little difficulty using the technology with minimal training.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates an embodiment of the support for the thimble for the apparatus of the present invention;

FIG. 2 illustrates an arrangement of the sample conduit and the absorber conduit relative to the thimble;

FIG. 3 illustrates one arrangement of the sample conduit and the absorber conduit relative to the thimble;

FIG. 4 illustrates one configuration of an apparatus and system; and

FIG. 5 illustrates one embodiment of a (pegboard) flow cell;

### DETAILED DESCRIPTION

### The Neutron Activation Thimble

A population of thermal neutrons, from medical grade, ²⁵²Cf source is employed to activate a flowing stream. An activation thimble has been developed to facilitate this. The thimble consists of a sample conduit wrapped around the circumference of a support.

When the apparatus includes an absorber conduit, preferably the conduit is located perpendicular and adjacent to the sample conduit. However, It is important to note that as the activation thimble increases in diameter, eventually a configuration including an absorber conduit will become ineffectual.

As an alternative the activation thimble can be designed to slide into a guide tube of suitable internal diameter inserted into a commercially supplied neutron source. A typical internal diameter of the tube would be, for example 1 cm to 2 cms. The dimensions of the activation thimble will need to be optimized empirically.

In an alternative embodiment, the guide tube may not be required. Specifically, a cylindrical cavity can be created by cutting or drilling a slab of borated paraffin containing a source. This can be achieved by the following steps;
1. The activation thimble is constructed with an external diameter smaller that the diameter of paraffin cylinder removed.
2. The activation thimble and sample conduit are placed in the cylindrical cavity.
3. The remaining void space in the cavity can be refilled with the paraffin removed previously (which may be machined or melted and reconfigured to an appropriate shape). Thus the activation thimble is sandwiched by the borated paraffin absorber.

### The Thimble Support

### Method for Making the Thimble Support

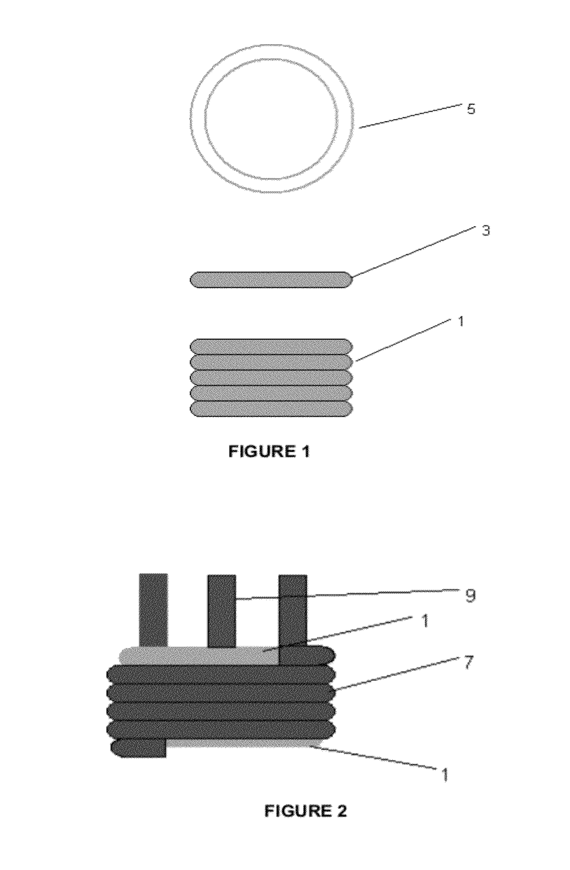

FIG. 1 shows the support for the activation thimble comprising five single plastic rings (1) as support elements. The rings can be made of any material of density that will not contribute significantly to decay spectrum. Uppermost in FIG. 1 is a plan view of a single support element (3) in side view, and in top view (5).

Any convenient number of support elements can be laminated together using an appropriate medium that will not contribute significantly to the decay spectrum. For example, plastic cement, contact adhesive and paraffin may be used.

Activation efficiency, lost through employing a less energetic source is regulated by the velocity of the flowing sample stream, proximity of the flowing sample stream to the neutron source and the presence of absorber material shielding the flowing sample stream.

The latter two are directly dependent on the dimensions of the activation thimble.

### The Sample Conduit

The sample may be moved through the sample conduit delivering sample aliquots to required positions around the flow system by any convenient means. Preferably the sample is moved under peristalsis. At the neutron source, the sample conduit is configured to form the activation thimble.

FIG. 2 shows the conformation established by coiling the sample conduit around a support to form the activation thimble. The neutron source is located adjacent the internal cylinder volume defined by the internal dimensions of the activation thimble. FIG. 2 shows the sample conduit (7) entering vertically from the upper left of the support (1). The conduit passes vertically down and out under the last element in the thimble support. The sample conduit coils around the outer circumference of the support and then runs vertically upward. Part of the absorber conduit (9) is also visible. The person skilled in the art will readily appreciate that this is not the only conformation possible with a flexible length of conduit. Variants will provide solutions when substantially thicker layers of absorber are required.

### The Absorber Conduit

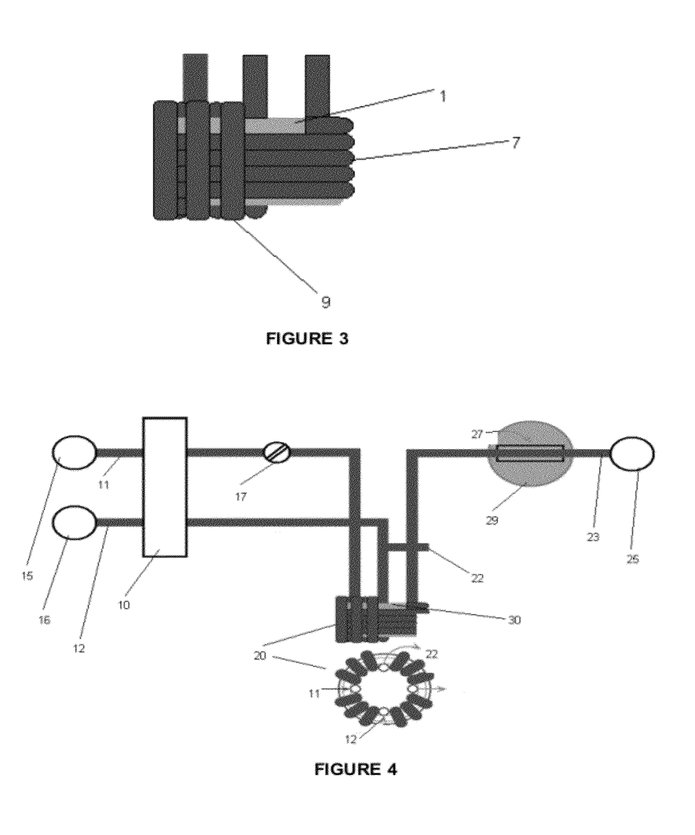

Borated paraffin or other materials comprising absorptive metals such as boron, cadmium or hafnium are commonly used as absorbers to yield the required thermal neutrons. The activation thimble and the sample conduit may be adjacent an absorber conduit. FIG. 3 shows an absorber conduit (9) entering the inside of the activation thimble vertically from the support centre. The absorber conduit passes vertically down and out under the last support element for the activation thimble. The absorber conduit coils laterally around the activation thimble. The absorber conduit coils around the conduit forming the activation thimble where space permits.

Because the absorber conduit passes over both the internal and external surface of the activation thimble, the supports for the thimble are sandwiched between layers of absorber. The number of turns of absorber conduit around the activation thimble determines the thickness of absorber material available to yield thermal neutrons. The sample conduit is sandwiched between absorber conduit coils that provide a mechanism to yield thermal neutrons. This arrangement allows for a thin layer of absorber to separate the sample conduit from the neutron source. This layer can be increased in thickness by wrapping subsequent absorber coils around the activation thimble.

### Preparing the Absorber Conduit

As long as the absorber reservoir and absorber conduit are held isothermally at the melting point of paraffin, the same peristalsis pump used to drive flow through the sample conduit can pump liquid paraffin through the absorber conduit. Once flow through the required length of conduit is achieved the end of the conduit is sealed and the paraffin is allowed to solidify.

### Configuration of the Apparatus

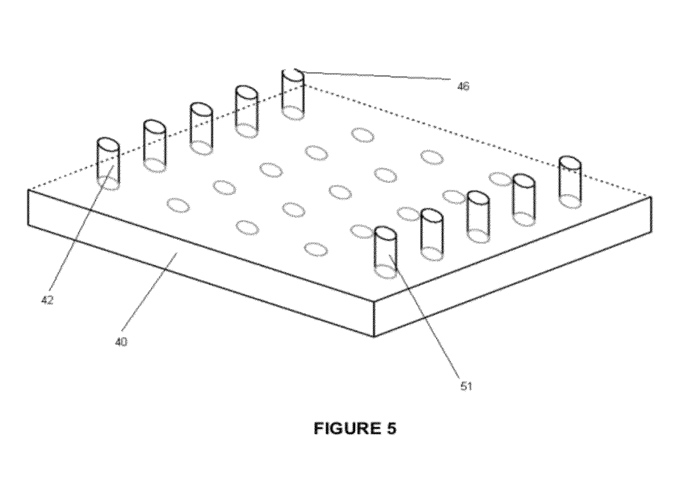

FIG. 4, illustrates a fundamental configuration of a flow system apparatus that allows the activation and detection of an aqueous stream containing nuclei of arbitrary concentration.

A peristaltic pump (10), draws liquid through ports (11) and (12) from (15) and (16) respectively and delivers the flowing streams at their requisite velocities. One port (11) is part of the sample conduit and the other port (12) is part of the absorber conduit.

A sampling valve, (17) is placed inline after the peristaltic pump to facilitate the delivery of a sample aliquot into the flowing carrier liquid or gas travelling along the sample conduit.

As previously outlined, the sample conduit passes down the guide tube into the borated paraffin of the neutron source housing. The sample conduit is wrapped in a radial configuration to form an activation thimble (20) also shown in plan view. The liquid lumen inside the sample conduit is irradiated, by close proximity to an amount of ²⁵²Cf, within the coils of the activation thimble.

The irradiated fluid is pumped out through outlet (22). Before passing out through outlet (23) into the waste reservoir (25), the liquid in the sample conduit passes through a flow cell (27). This flow cell contains a sample conduit that is conformed to allow an optimal residence time of the sample in the sample zone over a detector (29).

The absorber conduit (30) allows a stream of liquid absorber, borated paraffin, to be pumped so as to constitute a sandwich of absorber material to rest in close proximity to the sample conduit, near the ²⁵²Cf, activation source. The absorber conduit is wrapped laterally around a thimble support and concomitantly the sample conduit forming the activation thimble.

Although reservoir (16) contains liquid absorber, the absorber solution is driven through the absorber conduit to outlet (22). Note, this outlet is sealed and the liquid absorber is allowed to solidify.

The ²⁵²Cf activation source is aligned with the longitudinal axis of the activation thimble, but located below the activation thimble to maximize the cylindrical cross section of absorber through which the neutrons can be thermalised.

The complexity of the apparatus and the arrangement of the modules will depend on the application.

Conventional radiochemical decay detectors and accompanying electronics are used to acquire and store spectral data. The spectral data obtained by employing this approach will be a composite with possible contributions from the sample, the carrier stream, the sample conduit through which the carrier is flowing and the atmosphere surrounding the activation source and flow conduits.

### Laminar Flow Pegboard Flow Cell

The simplest flow cell designed to optimize the geometry with respect to the flowing carrier is the pegboard flow cell. FIG. 5 illustrates the basic features of the pegboard flow cell for placement parallel to the detector (either an α, β or γ counter). The flow cell comprises a perspex block (40) into which a 5×5 matrix of holes have been drilled. A maximum of ten pegs can be inserted in the matrix, each row having a maximum of two pegs.

The pegs in the pegboard (40) act as turning points around which conduit tubing can be flexed. In the configuration shown in FIG. 5 the sample conduit passes around the outside of the peg in the upper left corner of the diagram at the peg positioned at row 1, column 1 (42) [1,1] and runs in a straight line to the peg positioned at [5,1] (46). The conduit flow is turned 180° around the outside of peg [5,1] (46) by bending the conduit. The conduit is run back in the opposite direction to the outside of peg [1,2] and turned around the outside of this peg. This process is continued until the conduit passes around the outside of the peg at the bottom right, at position [5,5] (51). In this way straight line flow in the conduit is turned into transverse flow, back and forth across head of the detector to increase the probability of a radiochemical decay event in the carrier stream is optimally positioned to trigger a counting cycle.

With a 5×5 matrix of possible peg positions and adopting the linear, peg to peg conduit path, there are a possible 5 (first positions in a row) by a possible 4 (second positions in a row) by 5 (rows), or 100 conduit geometries over the detector.

### Neutron Activated Waste Management

The carrier waste flows away from the detector through the sample conduit, into a waste reservoir. Typically this is a sealed glass bottle with a screw cap in which the sample conduit is secured with a low-pressure fitting.

Once the waste reservoir is filled, the screw cap with the sample conduit attached is replaced with a conventional screw cap and the sealed waste container is stored. The same apparatus is employed, without diverting flow to the neutron source, to pass the waste carrier over α, β and/or γ counters to assay for the presence of species with long half-lives. This cycle of store and test is continued until a steady “safe” state is achieved.

This process does not address the presence of chemical toxins or contaminants in the carrier. It merely suggests a method for dealing with the radioactivity of carrier waste.

### Composition and Decomposition of Spectral Data

The composition of the spectral data is determined by simple difference. This approach is analogous to the one adopted in conventional analytical chemistry to assess the contribution of sample components on the detection of the analyte in the presence of interference or contamination.

### Method of Spectral Decomposition Prior to Sample Injection

By considering all material components exposed to activation the number of sample blanks run can be determined using the following method:
1. The apparatus is assembled as depicted in FIG. 4. The absorber conduit comprising borated paraffin is prepared as previously described. Intentionally, reservoir (15) is left empty.
2. The pump, (10) is started at the required flow rate. The reservoir (15) is filled with analytical grade water.
3. The interface between the water and the air in the sample conduit is observed and allowed to travel to the point where the interface is impinging on the sample conduit just prior to activation thimble. This process is described in the section headed “Pump Flow Calibration”.
4. Pump flow is suspended and the volume of air in front of the air, volume interface is irradiated. Included in this step is the irradiation of the sample conduit in the presence of air.
5. The period of “stopped flow” is determined empirically. Typically a longer period of irradiation would be preferable given the density of air and relative absence of more massive nuclei.
6. Once the desired activation of the air filled sample conduit is achieved, the air/water interface is allowed to stream to the entrance of the flow cell.
7. Pump flow is stopped and any radiochemical decay events are counted. Again the period of “stopped flow” needs to be sufficiently long to be considered statistically significant. This constitutes any background contributions from the sample conduit filled with atmospheric, permanent gas. This is the first blank.
8. Pump flow is started until the volume of water activated by the “stopped flow” step described above enters the flow cell. Pump flow is stopped for the same period of time as the “air” background described above. Counting statistics over this period are collected and this will provide the background contribution of the supporting, aqueous matrix of the carrier stream.
9. As a check, the background contribution from the sample conduit alone will indicate the possible reproducibility and significance of these background blanks.
10. Empty reservoir (15) and pump out the supporting aqueous matrix so as to displace all the liquid contents. Fill reservoir (15) with the carrier (if this is different in composition to the supporting aqueous matrix).
11. Steps 3 to 9 are repeated to obtain a duplicate background contribution from the sample conduit filled with permanent atmospheric gas. A background contribution is then measured from the sample conduit filled with the carrier to be used for the desired application.
12. The whole process is repeated until the desired level of reliability and reproducibility is achieved.

The person skilled in the art will appreciate that this method is consistent with conventional analytical chemistry. All qualitative and quantitative assertions are made with respect to an external or internal standard.

### Qualitative Determination of Unknown Spectral Components

The extraneous spectral components may be determined by blank determination and baseline extraction. Sample unknown identifications not accounted for through blank determination must be found by comparison with a certified, external, primary standard or a secondary standard calibrated against a primary standard. The primary standard will be application specific. In the case of a metal determination this could be a certified mixed metal standard obtained from a reputable supplier of flame atomic absorption spectrophotometric analysis or inductively coupled plasma atomic absorption spectrophotometric analysis consumables.

### Quantitative Determination of Unknown Spectral Components

Quantitative analysis is performed in compliance with conventional analytical methods that are well known to those skilled in the art. This is dependent upon the method of dealing with the sample matrix. The sample matrix generates a background spectrum independent of the sample blanks described above. There are two methods to deal with these spectral components from the sample. The sample matrix must be matched by any standards designed for quantification or the sample matrix must be destroyed to minimize any extraneous sample contributions to the spectral composite.

### Quantitative Determination and Matrix Matching

A standard additions approach can be used to match the sample matrix and generate a standard curve of detector response (counts) versus concentration according to the following method which will be known to those skilled in the art:
1. The number of standards required to make the analysis statistically robust is decided. The sample is then fractionated to accommodate the generation of the required standards. An extra fraction is included to allow for the generation of the sample blank.
2. Sufficient sample is retained to act as a “check standard” should the method need to be repeated.
3. An aliquot of the sample is delivered into a vial. This acts as the sample blank. An aliquot of this blank is injected to obtain statistically significant counting data.
4. An aliquot of standard solution is delivered into the sample blank and the volume noted. An aliquot of this standard solution is injected and obtain statistically significant counting data.
5. The previous step is repeated to deliver successive increasing volumes of standard solution following injection of each aliquot to obtain statistically significant counting data.
6. A detector response curve is plotted for the standard solutions. The line of best fit for this curve should be linear and extrapolated past the range axis back to the domain axis. The point at which the curve of best fit cuts the range axis is indicative of the concentration of the analyte in the sample.

### Quantitative Determination and Matrix Destruction

Known chemical or physical methodologies can be used to extract the analyte from the sample matrix.
1. The sample is added to a suitable and known diluent.
2. A suitable standard solution of sufficient concentration is serially diluted to yield a range of standard concentrations. Ideally, the detector response will be linear of the range of standard concentrations and the diluted sample will be bracketed between two of these standards.
3. An aliquot of diluent is injected as the sample blank to obtain statistically significant counting data. This should indicate the purity of the diluent.
4. An aliquot of diluted sample extract is injected to obtain statistically significant counting data.
5. An aliquot of each standard is injected to obtain statistically significant counting data at each concentration.
6. A detector response versus concentration, calibration curve is plotted for the standard concentrations.
7. The detector response for the sample is obtained from empirical observation and the concentration determined from the calibration curve.

### Method of Pump Calibration

Conventionally, peristaltic pumps are calibrated by measuring mass or volume delivered in a predetermined period of time. When transparent conduits are used a visual method can be employed to correlate against the conventional approach according to the following method.
1. A suitable length of transparent sample conduit is marked with suitable uniform graduations.
2. Reservoir (15) is filled with carrier and start pump, (10) to expel any permanent gas in the sample conduit.
3. The injection valve is activated to ensure complete filling of the valve's sample loop.
4. With the desired flow rate set and the carrier eluting, the injection valve's sampling loop is filled with a solution containing a chromophore active in the visible region of the EM spectrum. This solution should be of a concentration that provides good contrast between the sample zone and the carrier zones on either side of it.
5. The injection valve is activated and used to introduce the sample zone to the carrier stream. The sample zone should be visible in the carrier stream.
6. A stopwatch is used to record the time the sample zone front and tail reach or surpass each of the graduations marked on sample conduit.
7. A coefficient of variance is calculated for the sample zone front and tail will provide a point of correlation against the conventional approach to pump calibration described above.

### Analytical Determinations—Metals Determinations

Because of their relatively massive nuclei, metals in solution are prime candidates for neutron activation analysis. The apparatus depicted in FIG. 4 could be used for this application, with one minor change. The carrier in reservoir (15) would need to be a solution of weak mineral acid, run through the sample conduit over an extended period to protonate any active sites that might attract and bind the charged metal species.

The permitted energy transitions specific to any given metal nuclei can be used as the analytical probe. Sensitivity will be based on the probability of the interaction of incident thermalised neutrons with metal nuclei distributed throughout the solution bulk, within the sample conduit.

The possibility of secondary and higher order interactions are real and will contribute to the resultant spectra.

### Analytical Determinations—Automated Metals Determinations

By interfacing an auto-injection robot in front of the injection valve, (17) and using the data from the pump calibration previously described, the same apparatus can be used in an automated mode to facilitate high sample throughput.

It should be noted that “high sample throughput” is a relative term and will depend upon the resident time of the sample zone in both the activation thimble (time for efficient activation) and the flow cell over the detector (time to collect reliable counting statistics).

### Small Scale Chemical Synthesis—Grignard Reagents

Radio labelling is a well known approach to investigating reaction kinetics, both in vivo and in vitro. The cost of reagents and equipment can be prohibitive. Activation in flow mode may be a viable alternative for organometallic and organic compounds that contain atoms with relatively massive nuclei.

For example, labelled organometallic compounds can be produced by reacting alkali or alkaline earth metals with organic halides. When organic halides react with magnesium in the presence of diethyl ether the product is called a Grignard reagent.

By substituting a “lab-on-valve” sequential injection valve for the simpler flow injection valve, (17), two possible arrangements of the apparatus are suggested for the small scale chemical synthesis of Grignard reagents. (Lab-on-valve is a first generation integrated manifold that has been microfabricated onto a selector valve as described by Scampavia L K and Ruzicka J 2001 Analytical Sciences, Vol. 17, p. 429 Supplement.)

A new module could be added to facilitate the interaction of heterogeneous reactants, such as a column of loosely packed powdered magnesium with a “T”-junction at the head of the column. The head of the column is not packed and thus provides a mixing volume for the organic halide entering from one side and the diethyl ether entering from the other side.

Two embodiments of the apparatus are possible depending on the reactant to be activated by the incident neutrons. For example, in a first embodiment the powdered magnesium can be activated off line by placing it in a glass tube, stoppering the tube ends and placing the sealed tube in close proximity to the neutron source. After activation, the glass tube is removed, the ends unstopped and activated column placed on line. The SIA (sequential injection analysis) valve is assembled, the reaction allowed to proceed by drawing methyl halide from Reservoir (15) and diethyl ether from Reservoir (16), allowing them to mix and react with the activated packed column magnesium powder and allowing the product to flow from the tail of the column into a pegboard flow cell.

In the second embodiment of the apparatus, configuration Reservoir R1 is filled with methyl halide, Reservoir (16) is filled with diethyl ether. The sample conduit carries the methyl halide from Reservoir (15) into the activation thimble. The methyl halide is activated and flows to the head of a packed column containing powdered magnesium. A second conduit delivers diethyl ether to head of the packed column. The reaction proceeds over the length of the packed column and the product flows into the pegboard flow cell.

This approach can be used to provide reaction kinetic data for the formation of Grignards. The resulting organometallic halides can then be used as reactants in other chemical synthesis schemes depending on the half lives of the activated atomic species in the Grignard. A more complex apparatus can be built to pass the activated Grignard on for further reaction and possible kinetic rate elucidation.

### Chemical Synthesis-Preparation of Activated Platinum Antineoplastics

The apparatus and system of the present invention can be used for chemical synthesis or activation of other compounds. For example, platinum antineoplastics such as cisplatin

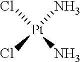

and carboplatin

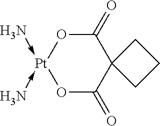

have formed the basis of chemotherapy since their inception around the middle of last century.

The planar structure of the platinum complex allows it to bind irreversibly between the carbohydrate strands that anchor the purine and pyrimidine base pairs of DNA. The resultant DNA is incapable of replication and the result is cell death.

The apparatus of the present invention can be used to provide incidental reaction kinetic data concerning the in vitro formation, in vivo distribution and metabolism of these established therapeutic actives. More importantly, the application of this neutron activation approach is the basis for the possibility of generating new radioactive platinum antineoplastics.

Essentially, an apparatus may be constructed as depicted in FIG. 4. An isotonic saline solution (9% w/v) is the carrier in Reservoir (15). Injections of platinum complex (in carrier solution as the diluent) are made into the carrier stream. The sample conduit delivers these injected sample zones in close proximity to the neutron source for activation.

The activated complex produces a molecule with its molecular geometry intact that retains its known pharmacological activity. However, it is now radioactive and once bound to DNA will irradiate molecular and cellular structures in proximity to it. This might possibly be optimised to yield further therapeutic benefit.

Initially, a pegboard flow cell can be used to collect counting statistics. Ultimately, post initial detection, an isolated tissue preparation or whole animal can be placed in line to investigate complex binding in vivo. This is possible since the activated platinum complex is dissolved in isotonic saline.

### Automation

It will be appreciated that many aspects of the apparatus and system may be automated. In particular, the means for introducing the fluid samples to the sample conduit and the detector are likely to be automated and computer controlled.

The computer control may involve a server. It should be noted that where the term “server” is used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that automation of the present invention is not limited to any particular logic flow or logic implementation. The logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of automated embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Any suitable computer programs for use with the present invention may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A nuclear activation apparatus for one or more fluid samples comprising the following modules;
a means for introducing one or more fluid samples to a sample conduit,
an activation thimble, comprising a section of sample conduit configured for multiple passes adjacent a radiation source,
an absorber located adjacent to the activation thimble, and
a detector located adjacent the sample conduit,
wherein the relative arrangement of the modules can be altered specific to an application and the rate of flow of the fluid sample adjacent the radiation source can be controlled.

2. An apparatus according to claim 1 wherein the nuclear activation is neutron activation.

3. An apparatus according to claim 1 which further comprises a flow cell.

4. A system for assembly of the nuclear activation apparatus of claim 1, the system comprising;
a first module including means for introducing one or more fluid samples to a sample conduit,
a second module including an activation thimble, comprising a section of sample conduit configured for multiple passes adjacent a radiation source,
a third module including an absorber located adjacent to the activation thimble, and
a fourth module comprising a detector located adjacent the sample conduit,
wherein the relative arrangement of the modules can be altered specific to an application and the rate of flow of the fluid sample adjacent the radiation source can be controlled.

5. A system according to claim 4 wherein the nuclear activation is neutron activation.

6. A system according to claim 4 wherein the system further comprises a flow cell.

7. An apparatus according to claim 1 when used for an application chosen from one or more of the following: radio labelling reactants for chemical synthesis; synthesis of radio labelled chemicals; activation of medical therapeutics; investigation of reaction kinetics; diagnostics; investigation reaction steps; and process monitoring.

8. A system according to claim 4 when used for an application chosen from one or more of the following: radio labelling reactants for chemical synthesis; synthesis of radio labelled chemicals; activation of medical therapeutics; investigation of reaction kinetics; diagnostics; investigation reaction steps; and process monitoring.

9. A method of calibrating a pump when used in the apparatus of claim 1 to control rate of flow of the fluid sample adjacent the radiation source, the method comprising the steps of:
(i) marking a length of the sample conduit with uniform graduations,
(ii) starting the pump to expel any gas in the sample conduit,
(iii) filling a sample loop within the sample introduction means with a solution containing a chromophore active in the visible region of the electromagnetic spectrum to form a sample zone,
(iv) activating the sample introduction means to introduce the sample zone to a carrier stream in the sample conduit,
(v) record the time taken for the sample zone front and tail to reach each of the graduations marked on sample conduit, and
(vi) calculating pumping rate based on the times recorded.

10. A method of calculating the background contribution of a carrier in the apparatus according to claim 1 including a sample pump and sample cell, the method comprising the steps of:
(i) pumping a first component of the carrier through the sample conduit at a required flow rate until it reaches a point just prior to the activation thimble;
(ii) suspending pumping while a volume of the first component (first blank) is irradiated;
(iii) recommencing pumping until the first blank enters of the flow cell;
(iv) suspending pumping to count radiochemical decay events in the first blank for a time t;
(v) pumping to expel the first blank from the sample conduit;
(vi) pumping a second and any subsequent components of the carrier into the sample conduit and repeating steps (i) to (v); and
(vii) using the counts from the first and any subsequent blanks to calculate background radiochemical decay.

11. A method of background spectral decomposition using the apparatus according to claim 1 including a sample pump and sample cell, the method comprising the steps of:
(i) pumping water through the sample conduit at a required flow rate until the meniscus of the air/water interface reaches a point just prior to the activation thimble;
(ii) suspending pumping while a volume of air (first blank) in front of the meniscus and a volume of water (second blank) are irradiated;
(iii) recommencing pumping until the meniscus reaches the entrance of the flow cell;
(iv) suspending pumping to count radiochemical decay events in the first blank for a time t;
(v) recommencing pump flow until the second blank enters the flow cell;
(vi) suspending pumping to count radiochemical decay events in the second blank for time t;
(vii) using the counts from the first blank and the second blank to calculate background radiochemical decay;
(viii) pumping to expel the first and second blanks from the sample conduit;
(ix) pumping carrier into the sample conduit and repeating steps (iii) to (vii).

12. A sample activation thimble for location adjacent a source of a radiation in the activation apparatus of claim 1, the thimble comprising a conduit configured in a series of coils wherein a sample passing along the conduit can be subjected to an extended residence time in radiation emitted from the source.

13. A sample activation thimble according to claim 12 which further includes a support configured in a series of coils.

14. An apparatus according to claim 2 which further comprises a flow cell.

15. A system according to claim 5 wherein the system further comprises a flow cell.
